(19) United States
(12) Patent Application Publication
(10) Pub. No.: US 2007/0274898 A1
(43) Pub. Date: Nov. 29, 2007

(54) PROCESSES FOR THE PREPARATION OF CHLORINE FROM HYDROGEN CHLORIDE AND OXYGEN

(75) Inventors: Rainer Weber, Odenthal (DE); Andreas Bulan, Langenfeld (DE); Michel Haas, Dormagen (DE); Rafael Warsitz, Essen (DE); Knud Werner, Krefeld (DE)

Correspondence Address: CONNOLLY BOVE LODGE & HUTZ, LLP, P O BOX 2207, WILMINGTON, DE, 19899, US

(73) Assignee: Bayer Material Science AG, Leverkusen (DE)

(21) Appl. No.: 11/752,410

(22) Filed: May 23, 2007

(30) Foreign Application Priority Data
May 23, 2006 (DE) 10 2006 024 506.7

(51) Int. Cl. C01B 7/04

(52) U.S. Cl. 423/502

(57) ABSTRACT

A process is disclosed comprising: (a) reacting hydrogen chloride and an oxygen-containing gas to form a gas mixture comprising chlorine, water, unreacted hydrogen chloride, and unreacted oxygen, wherein the oxygen-containing gas reacted with the hydrogen chloride has an oxygen content of not more than 99 vol. %; (b) cooling the gas mixture to form an aqueous solution of hydrogen chloride; (c) separating at least a portion of the aqueous solution of hydrogen chloride from the gas mixture; and (d) subjecting the gas mixture to a gas permeation to form a chlorine-rich gas stream and an oxygen-containing partial stream.

### BACKGROUND OF THE INVENTION

In the preparation of a large number of chemical compounds using chlorine and/or phosgene, for example the preparation of isocyanates or the chlorination of aromatic compounds, hydrogen chloride is obtained as a by-product. The hydrogen chloride can be converted back into chlorine by electrolysis or by oxidation with oxygen, it being possible for the chlorine to be used again in chemical reactions. The oxidation of hydrogen chloride (HCl) to chlorine (Cl₂) takes place by reaction of hydrogen chloride and oxygen (O₂) according to
4HCl+O₂→2 Cl₂+2 H₂O

The reaction can be carried out in the presence of catalysts at temperatures of approximately from 200° C. to 450° C. Suitable catalysts for the Deacon processes contain transition metal compounds such as copper and ruthenium compounds, or also compounds of other metals such as gold, palladium and bismuth. Such catalysts are described, for example, in the specifications: DE 1567788 A1, EP 251731 A2, EP 936184 A2, EP 761593 A1, EP 711599 A1 and DE 10250131 A1. The catalysts are generally applied to a support. Such supports consist, for example, of silicon dioxide, aluminium oxide, titanium dioxide or zirconium oxide.

The Deacon processes are generally carried out in fluidised bed reactors or fixed bed reactors, preferably tubular reactors. In the known processes, hydrogen chloride is freed of impurities before the reaction in order to avoid contamination of the catalysts that are used.

Oxygen is generally used in the form of pure gas having an O₂ content of >99 vol. %.

A common feature of all the known processes is that the reaction of hydrogen chloride with oxygen yields a gas mixture that contains, in addition to the target product chlorine, also water, unreacted hydrogen chloride and oxygen, as well as further minor constituents such as carbon dioxide. In order to obtain pure chlorine, the product gas mixture is cooled after the reaction to such an extent that water of reaction and hydrogen chloride condense out in the form of concentrated hydrochloric acid. The resulting hydrochloric acid is separated off and the gaseous reaction mixture that remains is freed of residual water by washing with sulfuric acid or by other methods such as drying with zeolites. The reaction gas mixture, which is then free of water, is subsequently compressed, whereby oxygen and other gas constituents remain in the gas phase and can be separated from the liquefied chlorine. Such processes for obtaining pure chlorine from gas mixtures are described, for example, in Offenlegungsschriften DE 19535716 A1 and DE 10235476 A1. The purified chlorine is then conveyed to its use, for example in the preparation of isocyanates.

A fundamental disadvantage of the above-mentioned chlorine preparation processes is the comparatively high outlay in terms of energy that is required to liquefy the chlorine gas stream.

A further disadvantage is that the liquefaction of the chlorine gas stream leaves behind an oxygen-containing gas phase that still contains considerable amounts of chlorine gas as well as other minor constituents such as carbon dioxide. This chlorine- and oxygen-containing gas phase is conventionally fed back into the reaction of hydrogen chloride with oxygen. Because of the minor constituents that are also present, in particular carbon dioxide and oxygen, part of this gas stream must be discharged and disposed of in order to prevent excessive concentration of those minor constituents in the substance circuit. However, some of the valuable products chlorine and oxygen are lost at the same time. In addition, the gas stream discharged from the process as a whole must be fed to an additional waste gas treatment, which further impairs the economy of the process. In order to minimise the loss of the valuable products chlorine and oxygen, it is necessary in the known processes to use as the oxygen source oxygen that is as pure as possible, with an O₂ content of greater than 99 vol. %, which likewise has an adverse effect on the economy of the process as a whole. Pure oxygen is obtained commercially from the liquefaction of air, which is very expensive in terms of energy.

### BRIEF SUMMARY OF THE INVENTION

It has been found that the aforementioned disadvantages can be overcome if, when a gas mixture is prepared by reacting hydrogen chloride and low purity oxygen, optionally after drying (i.e., removal of at least a portion of the water from the gas mixture), the chlorine-containing gas mixture is not subjected to chlorine liquefaction, but instead, is freed of oxygen and other minor constituents via gas permeation. Thus, it is possible, and significantly more economically favorable, to use oxygen-containing gas having an O₂ content of less than 99 vol. %.

The present invention relates, in general, to processes for the preparation of chlorine by thermal reaction of hydrogen chloride with oxygen using catalysts, in which the gas mixture formed in the reaction, which consists at least of the target products chlorine and water, unreacted hydrogen chloride and oxygen, as well as further minor constituents such as carbon dioxide and nitrogen, and optionally phosgene, is cooled in order to condense hydrochloric acid, the resulting liquid hydrochloric acid is separated from the gas mixture, and the residues of water that remain in the gas mixture are removed, in particular by washing with concentrated sulfuric acid, and wherein the chlorine formed is separated from the gas mixture or the concentration of chlorine in the gas mixture is enriched via gas permeation. The invention relates specifically to the operation of the process using air or oxygen of low purity.

The term “gas permeation” is generally to be understood as meaning the selective separation of components of a gas mixture via one or more membranes. Methods of gas permeation are known in principle and are described, for example, in “T. Melin, R. Rautenbach; Membranverfahren—Grundlagen der Modul—und Anlagenauslegung; 2nd Edition; Springer Verlag 2004”, Chapter 1, p. 1-17 and Chapter 14, p. 437-439 or “Ullmann, Encyclopedia of Industrial Chemistry; Seventh Release 2006; Wiley-VCH Verlag”, the entire contents of each of which are hereby incorporated herein by reference.

One embodiment of the present invention includes a process comprising: (a) reacting hydrogen chloride and an oxygen-containing gas to form a gas mixture comprising chlorine, water, unreacted hydrogen chloride, and unreacted oxygen, wherein the oxygen-containing gas reacted with the hydrogen chloride has an oxygen content of not more than 99 vol. %; (b) cooling the gas mixture to form an aqueous solution of hydrogen chloride; (c) separating at least a portion of the aqueous solution of hydrogen chloride from the gas mixture; and (d) subjecting the gas mixture to a gas permeation to form a chlorine-rich gas stream and an oxygen-containing partial stream.

Various preferred embodiments of the present invention can further include feeding at least a portion of the oxygen-containing partial stream to the reaction of hydrogen chloride with the oxygen-containing gas to form the gas mixture. In various preferred embodiments of the present invention, the hydrogen chloride reacted with the the oxygen-containing gas to form the gas mixture can comprise a product of an isocyanate preparation process, and at least a portion of the chlorine-rich gas stream is supplied to the isocyanate preparation process. Additionally, in various preferred embodiments of the present invention, the hydrogen chloride reacted with the oxygen-containing gas to form the gas mixture can comprise a product of an isocyanate preparation process, and at least a portion of the chlorine-rich gas stream is supplied to the isocyanate preparation process; and at least a portion of the oxygen-containing partial stream can be fed to the reaction of hydrogen chloride with the oxygen-containing gas to form the gas mixture.

### BRIEF DESCRIPTION OF THE SEVERAL VIEWS OF THE DRAWING

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a representative flowchart of a chlorine oxidation with a two-stage gas permeation according to one embodiment of the present invention; and

FIG. 2 is a diagrammatic representation of a permeation test apparatus.

### DETAILED DESCRIPTION OF THE INVENTION

As used herein, the singular terns “a” and “the” are synonymous and used interchangeably with “one or more.” Accordingly, for example, reference to “a gas” herein or in the appended claims can refer to a single gas or more than one gas. Additionally, all numerical values, unless otherwise specifically noted, are understood to be modified by the word “about.”

Processes according to various embodiments of the present invention are preferably carried out continuously, because batchwise or semi-batchwise operation, which is also included within the present invention, can be slightly more complex and/or less economically favorable than a continuous process.

In various preferred embodiments of the processes according to the invention, residues of water remaining in the gas mixture can be removed, preferably by washing with concentrated sulfuric acid. Drying has the advantage that the formation of liquid hydrochloric acid in subsequent apparatuses can be avoided (no corrosion), so that the use of higher-quality materials in those apparatus parts can be dispensed with.

In various preferred embodiments of the processes according to the invention, residues of hydrogen chloride that remain can be removed before or after the chlorine separation carried out by gas permeation. The removal of hydrogen chloride likewise has the advantage that the formation of liquid hydrochloric acid from hydrogen chloride and traces of water can be avoided. The removal of any residues of hydrogen chloride that remain can preferably be carried out directly after the separation of the condensed hydrochloric acid. The removal of any residues of hydrogen chloride that remain is very particularly preferably carried out by absorption, in particular by washing with water.

In various preferred embodiments of processes according to the invention, an oxygen-containing gas having an oxygen content of not more than 98 vol. % is used in the reaction with hydrogen chloride. In increasingly more preferred embodiments, the oxygen-containing gas can have an oxygen content of not more than 97 vol. %, not more than 96 vol. %, not more than 95 vol. %, and not more than 94 vol+%, For example, “technically” pure oxygen having an oxygen content of typically 93.5 vol. %, obtainable according to the so-called “PSA process”, can be used. The production of oxygen according to the PSA process is described, for example, in Ullmann's Encyclopedia of Industrial Chemistry—the Ultimate Reference, Release 2006, 7th Edition, the entire contents of which are incorporated herein by reference. The oxygen produced according to the PSA process is generally markedly less expensive than oxygen produced by the cryogenic decomposition of air. Oxygen-containing gases having even lower contents of oxygen, for example air and air enriched with oxygen, can preferably be used as well.

The separation of components in the gas mixture via gas permeation that is carried out in the processes according to the various embodiments of the present invention is preferably carried out using membranes that operate according to the molecular sieve principle, which are described, for example, in Chapter 3.4 of T. Melin, R. Rautenbach;

Membranverfahren—Grundlagen der Modul—und Anlagenauslegung; 2nd Edition; Springer Verlag 2004, p. 96-105, the entire contents of which are hereby incorporated herein by reference. Membranes that are preferably used are molecular sieve membranes comprising carbon and/or SiO₂ and/or zeolites. Though not bound by any particular theory of gas permeation kinetics, in a separation according to the molecular sieve principle, the minor components, for example, which have a smaller kinetic, i.e., Leonard-Jones, diameter than the main component chlorine, are separated by longer retention times within the sieve.

In various preferred embodiments of the present invention, the effective pore size of a molecular sieve used in a gas permeation is 0.2 to 1 nm, more preferably 0.3 to 0.5 nm.

Gas permeation to separate oxygen and optionally minor constituents from the chlorine-containing gas mixture, can provide a very pure chlorine gas, and in addition the energy requirement for the chlorine gas purification carried out by a process according to the invention is markedly reduced as compared with the liquefication processes known hitherto. The gas mixture obtained as a further gas stream may contain substantially oxygen and, as minor constituents, carbon dioxide and optionally nitrogen, and is substantially free of chlorine.

A gas stream which is substantially free of chlorine, as used herein, refers to a content of not more than 1 wt. % chlorine in the gas stream. In various more preferred embodiments, the oxygen-containing sidestream can have a content of not more than 1000 ppm chlorine, and most preferably not more than 100 ppm chlorine

Gas permeation is preferably carried out using so-called carbon membranes. Suitable carbon membranes include those comprised of pyrolyzed polymers, for example pyrolyzed polymers from the group: phenolic resins, furfuryl alcohols, cellulose, polyacrylonitriles and polyimides. Such membranes are described, for example, in Chapter 2.4 of T. Melin, R. Rautenbach; Membranverfahren—Grundlagen der Modul—und Anlagenauslegung; 2nd Edition; Springer Verlag 2004, p. 47-59, the entire contents of which are hereby incorporated herein by reference.

In various preferred embodiments, gas permeation can be carried out at a pressure differential between the incoming stream and the outgoing stream (chlorine) of up to 10⁵ hPa (100 bar), more preferably from 500 to 4·10⁴ hPa (from 0.5 to 40 bar). Particularly preferable operating pressures for the treatment of chlorine-containing gas streams include pressures of 7000 to 12,000 hPa (from 7 to 12 bar).

In various preferred embodiments, gas permeation can be carried out at a temperature of the incoming gas mixture to be separated of up to 400° C., more preferably up to 200° C., and most preferably up to 120° C.

A further preferred embodiment of a process according to the invention is characterized in that air or air enriched with oxygen is used as the oxygen-containing gas for the reaction of hydrogen chloride with oxygen, and in that the oxygen-containing side stream is optionally discarded. For example, the oxygen-containing side stream, optionally after preliminary purification, can be released directly into the surrounding air in a controlled manner, or part thereof can be recirculated.

Various preferred embodiments wherein the oxygen-containing side stream separated from chlorine is disposed of or discarded has the advantage that, in cyclic processes, there is no pronounced concentration of minor components such as carbon dioxide in the system circuit, which in processes according to the prior art makes necessary the discharge of a significant amount or the more expensive purification of at least part of the recirculated oxygen-containing gas stream. Such discharge leads to considerable losses of oxygen and chlorine, which adversely affects the economy of the known process as a whole for the preparation of chlorine by reaction of hydrogen chloride with pure oxygen.

A further disadvantage of the known HCl oxidation processes is that pure oxygen having an O₂ content of in most cases more than 99 vol. % must be used in the oxidation of hydrogen chloride.

Processes in accordance with various embodiments of the present invention make it possible to dispense with the use of pure oxygen (>99%).

Further particularly preferred embodiments of processes according to the invention include the use of air or air enriched with oxygen as the oxygen-containing gas for the reaction of hydrogen chloride with oxygen.

Embodiments using air or air enriched with oxygen have further advantages. On the one hand, the use of air instead of pure oxygen eliminates a considerable cost factor, because the working-up of air is substantially less complex in technical terms than the recovery of pure oxygen. Because an increase in the oxygen content displaces the reaction equilibrium in the direction of chlorine preparation, the amount of inexpensive air or oxygen-enriched air can be increased, if necessary, without hesitation.

Furthermore, a major problem of the known Deacon processes and Deacon catalysts is the occurrence of hot-spots at the surface of the catalyst, which is very difficult to control. Overheating of the catalyst readily leads to irreversible damage to the catalyst, which impairs the oxidation process. Various attempts have been made to avoid such local overheating (e.g., by diluting the bulk catalyst), but have not provided satisfactory solutions. An air mixture containing, for example, up to 80% inert gases permits dilution of the feed gases (reactants) and accordingly also a controlled reaction procedure by avoiding local overheating of the catalyst. The development of heat is inhibited by the use of this preferred measure, and consequently the useful life of the catalyst is increased (by reducing the volume-based activity of the catalyst). Furthermore, the use of inert gas components will result in better heat dissipation (absorption of heat by the inert gases), which additionally contributes to preventing hot-spots.

Although it is known in principle from the prior art according to EP-184413-B1, FR1497776 that HCl oxidation using air or air enriched with oxygen is wholly possible, this procedure is unsuccessful technically because of the complex and expensive working-up of the Deacon reaction products caused by these known methods with the conventionally known working-up steps. In addition, these processes are unsuccessful because of the inadequate separation of the residual gas from the chlorine, which is an expensive valuable substance, the majority of which is lost because of a high discharge of waste gases, which the use of air or of air enriched with oxygen requires. With an inert gas content of, for example, up to 80 vol. %, it is not expedient in the known processes to recirculate the inert gases containing residual chlorine in order to recover residual chlorine, whose content in the residual gas can reach up to 10% (DE-10235476-A1). Accordingly, at least part of the purified process gas must be discarded, which means the loss of a large amount of chlorine and high destruction costs of the residual gases, and which consequently impairs the economy of the known process considerably.

The efficient working up of process gas that is provided by the various embodiments of the present invention, allow for carrying out a Deacon process using commercial oxygen of low purity or using air or air enriched with oxygen. By the use of membranes, the chlorine can successfully be separated from oxygen, optionally nitrogen and further minor components. Chlorine obtained by a process according to the invention can then be reacted according to processes known in the art, for example with carbon monoxide to give phosgene, which can be used for the preparation of MDI or TDI from MDA or TDA, respectively.

As already described above, a catalytic process known as a Deacon process can preferably be used to react hydrogen chloride with the oxygen-containing gas. In such a process, hydrogen chloride is oxidized with oxygen in an exothermic equilibrium reaction to give chlorine, with the formation of water vapour. The reaction temperature can be 150 to 500° C., and the reaction pressure can be 1 to 25 bar. Because this is an equilibrium reaction, it is preferable to work at the lowest possible temperatures at which the catalyst still exhibits sufficient activity. Furthermore, it is preferable to use oxygen in more than stoichiometric amounts. A two- to four-fold oxygen excess, for example, is preferred. Because there is no risk of selectivity losses, it can be economically advantageous to work at a relatively high pressure and accordingly with a longer dwell time compared with normal pressure.

Suitable preferred catalysts for the Deacon process contain ruthenium oxide, ruthenium chloride or other ruthenium compounds on silicon dioxide, aluminium oxide, titanium dioxide or zirconium dioxide as support. Suitable catalysts can be obtained, for example, by applying ruthenium chloride to the support and then drying or drying and calcining. In addition to or instead of a ruthenium compound, suitable catalysts can also contain compounds of different noble metals, for example gold, palladium, platinum, osmium, iridium, silver, copper or rhenium. Suitable catalysts can also contain chromium(III) oxide or bismuth compounds.

The catalytic oxidation of hydrogen chloride can be carried out adiabatically or, preferably, isothermally or approximately isothermally, discontinuously, but preferably continuously, as a fluidised or fixed bed process, preferably as a fixed bed process, particularly preferably in tubular reactors on heterogeneous catalysts at a reactor temperature of 180 to 500° C., preferably 200 to 400° C., particularly preferably 220 to 350° C., and a pressure of 1 to 25 bar (from 1000 to 25,000 hPa), preferably 1.2 to 20 bar, particularly preferably 1.5 to 17 bar and especially 2.0 to 15 bar.

Suitable reaction apparatuses in which the catalytic oxidation of hydrogen chloride can be carried out include fixed bed or fluidised bed reactors. The catalytic oxidation of hydrogen chloride can preferably also be carried out in a plurality of stages.

In the case of the isothermal or approximately isothermal procedure, it is also possible to use a plurality of reactors, that is to say from 2 to 10, preferably from 2 to 6, particularly preferably from 2 to 5, especially from 2 to 3 reactors, connected in series with additional intermediate cooling. The oxygen can be added either in its entirety, together with the hydrogen chloride, upstream of the first reactor, or distributed over the various reactors. This series connection of individual reactors can also be combined in one apparatus.

A further preferred embodiment of a device suitable for use in a process according to the invention comprises using a structured bulk catalyst in which the catalytic activity increases in the direction of flow. Such structuring of the bulk catalyst can be effected by variable impregnation of the catalyst support with active substance or by variable dilution of the catalyst with an inert material. There can be used as the inert material, for example, rings, cylinders or spheres of titanium dioxide, zirconium dioxide or mixtures thereof, aluminium oxide, steatite, ceramics, glass, graphite or stainless steel. In the case of the use of catalyst shaped bodies, which is preferred, the inert material should preferably have similar outside dimensions.

Suitable catalyst shaped bodies include shaped bodies of any shape, preferred shapes being lozenges, rings, cylinders, stars, cart wheels or spheres and particularly preferred shapes being rings, cylinders or star-shaped extrudates.

Suitable heterogeneous catalysts include in particular ruthenium compounds or copper compounds on support materials, which can also be doped, with preference being given to optionally doped ruthenium catalysts. Examples of suitable support materials are silicon dioxide, graphite, titanium dioxide of rutile or anatase structure, zirconium dioxide, aluminium oxide or mixtures thereof, preferably titanium dioxide, zirconium dioxide, aluminium oxide or mixtures thereof, particularly preferably γ- or δ-aluminium oxide or mixtures thereof.

The copper or ruthenium supported catalysts can be obtained, for example, by impregnating the support material with aqueous solutions of CuCl₂ or RuCl₃ and optionally of a promoter for doping, preferably in the form of their chlorides. Shaping of the catalyst can take place after or, preferably, before the impregnation of the support material.

Suitable promoters for the doping of the catalysts include alkali metals such as lithium, sodium, potassium, rubidium and caesium, preferably lithium, sodium and potassium, particularly preferably potassium, alkaline earth metals such as magnesium, calcium, strontium and barium, preferably magnesium and calcium, particularly preferably magnesium, rare earth metals such as scandium, yttrium, lanthanum, cerium, praseodymium and neodymium, preferably scandium, yttrium, lanthanum and cerium, particularly preferably lanthanum and cerium, or mixtures thereof.

The shaped bodies can then be dried and optionally calcined at a temperature of from 100 to 400° C., preferably from 100 to 300° C., for example, under a nitrogen, argon or air atmosphere. The shaped bodies are preferably first dried at from 100 to 150° C. and then calcined at from 200 to 400° C.

The hydrogen chloride conversion in a single pass can preferably be limited to from 15 to 90%, preferably from 40 to 85%, particularly preferably from 50 to 70%. After separation, all or some of the unreacted hydrogen chloride can be fed back into the catalytic hydrogen chloride oxidation. The volume ratio of hydrogen chloride to oxygen at the entrance to the reactor is preferably from 1:1 to 20:1, particularly preferably from 2:1 to 8:1, very particularly preferably from 2:1 to 5:1.

The heat of reaction of the catalytic hydrogen chloride oxidation can advantageously be used to produce high-pressure steam. This can be used, for example, to operate a phosgenation reactor and/or distillation columns, in particular isocyanate distillation columns.

The chlorine formed in the Deacon oxidation is separated from the remainder of the gas mixture by the processes according to the various embodiments of the present invention. The separation of the chlorine preferably comprises a plurality of stages, namely the separation and optional recirculation of unreacted hydrogen chloride from the product gas stream of the catalytic hydrogen chloride oxidation, drying of the resulting stream containing substantially chlorine and oxygen, and separation of chlorine from the dried stream.

The separation of unreacted hydrogen chloride and of water vapour that has formed can be carried out by condensing aqueous hydrochloric acid from the product gas stream of the hydrogen chloride oxidation by cooling. Hydrogen chloride can also be absorbed in dilute hydrochloric acid or water.

Further preferred embodiments of processes according to the invention are characterized in that the hydrogen chloride used as a starting material can include a product of an isocyanate preparation process, and/or in that the purified chlorine gas freed of oxygen and optionally of minor constituents can be used in a preparation of isocyanates. Particularly preferred are those embodiments in which the hydrogen chloride used as a starting material can include a product of an isocyanate preparation process, and the purified chlorine gas freed of oxygen and optionally of minor constituents can be used in the isocyanate preparation process.

A particular advantage of such a combined process is that conventional chlorine liquefaction can be dispensed with and the chlorine for recirculation into the isocyanate preparation process is available at approximately the same pressure level as the inlet stage of the isocyanate preparation process.

The combined process according to such preferred embodiments accordingly includes an integrated process for the preparation of isocyanates and the oxidation of hydrogen chloride to recover chlorine for the synthesis of phosgene as starting material for the preparation of isocyanates.

In a first step of such a preferred process, the preparation of phosgene takes place by reaction of chlorine with carbon monoxide. The synthesis of phosgene is sufficiently well known and is described, for example, in Ullmanns Enzylclopädie der industriellen Chemie, 3rd Edition, Volume 13, pages 494-500. On an industrial scale, phosgene is predominantly produced by reaction of carbon monoxide with chlorine, preferably on activated carbon as a catalyst. The strongly exothermic gas phase reaction takes place at temperatures of from at least 250° C. to not more than 600° C., generally in tubular reactors. The heat of reaction can be dissipated in various ways, for example by means of a liquid heat-exchange agent, as described, for example, in WO 03/072237, the entire contents of which are incorporated herein by reference, or by vapour cooling via a secondary cooling circuit while simultaneously using the heat of reaction to produce steam, as disclosed, for example, in U.S. Pat. No. 4,764,308, the entire contents of which are incorporated herein by reference.

In a subsequent process step of such a preferred process, at least one isocyanate is formed from the phosgene formed in the first step, by reaction with at least one organic amine or with a mixture of two or more amines. This process step is also referred to hereinbelow as phosgenation. The reaction takes place with the formation of hydrogen chloride as by-product, which is obtained in the form of a mixture with the isocyanate.

The synthesis of isocyanates is likewise known in principle from the prior art, phosgene generally being used in a stoichiometric excess, based on the amine. The phosgenation is preferably carried out in the liquid phase, it being possible for the phosgene and the amine to be dissolved in a solvent. Preferred solvents for the phosgenation are chlorinated aromatic hydrocarbons, such as chlorobenzene, o-dichlorobenzene, p-dichlorobenzene, trichlorobenzenes, the corresponding chlorotoluenes or chloroxylenes, chloroethylbenzene, monochlorodiphenyl, α- or β-naphthyl chloride, benzoic acid ethyl ester, phthalic acid dialkyl esters, diisodiethyl phthalate, toluene and xylenes. Further examples of suitable solvents are known in principle from the prior art. As is additionally known from the prior art, for example according to specification WO 96/16028, the resulting isocyanate itself can also serve as the solvent for phosgene. In another, preferred embodiment, the phosgenation, in particular of suitable aromatic and aliphatic diamines, takes place in the gas phase, that is to say above the boiling point of the amine. Gas-phase phosgenation is described, for example, in EP 570 799 A1. Advantages of this process over liquid-phase phosgenation, which is otherwise conventional, are the energy saving, which results from the minimisation of a complex solvent and phosgene circuit.

Suitable organic amines are preferably any primary amines having one or more primary amino groups which are able to react with phosgene to form one or more isocyanates having one or more isocyanate groups. The amines have at least one, preferably two, or optionally three or more primary amino groups. Accordingly, suitable organic primary amines are aliphatic, cycloaliphatic, aliphatic-aromatic, aromatic amines, diamines and/or polyamines, such as aniline, halo-substituted phenylamines, for example 4-chlorophenylamine, 1,6-diaminohexane, 1-amino-3,3,5-trimethyl-5-amino-cyclohexane, 2,4-, 2,6-diaminotoluene or mixtures thereof, 4,4′-, 2,4′- or 2,2′-diphenylmethanediamine or mixtures thereof, as well as higher molecular weight isomeric, oligomeric or polymeric derivatives of the mentioned amines and polyamines. Further possible amines are known in principle from the prior art. Preferred amines for the present invention are the amines of the diphenylmethanediamine group (monomeric, oligomeric and polymeric amines), 2,4-, 2,6-diaminotoluene, isophoronediamine and hexamethylenediamine. In the phosgenation, the corresponding isocyanates diisocyanatodiphenylmethane (MDI, monomeric, oligomeric and polymeric derivatives), toluylene diisocyanate (TDI), hexamethylene diisocyanate (HDI) and isophorone diisocyanate (IPDI) are obtained.

The amines can be reacted with phosgene in a single-stage or two-stage or, optionally, a multi-stage reaction. Both a continuous and a discontinuous procedure are possible.

If a single-stage phosgenation in the gas phase is chosen, the reaction is preferably carried out above the boiling temperature of the amine, preferably within a mean contact time of from 0.5 to 5 seconds and at temperatures of from 200 to 600° C.

In the case of phosgenation in the liquid phase, temperatures of from 20 to 240° C. and pressures of from 1 to about 50 bar are preferably used. Phosgenation in the liquid phase can be carried out in a single stage or in a plurality of stages, it being possible to use phosgene in a stoichiometric excess. The amine solution and the phosgene solution are combined via a static mixing element and then guided through one or more reaction columns, for example from bottom to top, where the mixture reacts completely to form the desired isocyanate. In addition to reaction columns provided with suitable mixing elements, reaction vessels having a stirrer device can also be used. As well as static mixing elements, it is also possible to use special dynamic mixing elements. Suitable static and dynamic mixing elements are known in principle from the prior art.

For example, continuous liquid-phase isocyanate production on an industrial scale is generally carried out in two stages. In the first stage, generally at a temperature of not more than 220° C., preferably not more than 160° C., the carbamoyl chloride is formed from amine and phosgene and amine hydrochloride is formed from amine and cleaved hydrogen chloride. This first stage is highly exothermic. In the second stage, both the carbamoyl chloride is cleaved to isocyanate and hydrogen chloride and the amine hydrochloride is reacted to carbamoyl chloride. The second stage is generally carried out at a temperature of at least 90° C., preferably from 100 to 240° C.

After the phosgenation, the isocyanates formed in the phosgenation are preferably separated off. This can be effected by first separating the reaction mixture of the phosgenation into a liquid and a gaseous product stream in a manner known in principle to the person skilled in the art. The liquid product stream contains substantially the isocyanate or isocyanate mixture, the solvent and a small part of unreacted phosgene. The gaseous product stream consists substantially of hydrogen chloride gas, phosgene in stoichiometric excess, and small amounts of solvent and inert gases, such as, for example, nitrogen and carbon monoxide. Furthermore, the liquid stream is then conveyed to a working-up step, preferably working up by distillation, wherein phosgene and the solvent for the phosgenation are separated off in succession. In addition, further working up of the resulting isocyanates is optionally carried out, for example by fractionating the resulting isocyanate product in a manner known to the person skilled in the art.

The hydrogen chloride obtained in the reaction of phosgene with an organic amine generally contains organic minor constituents, which in the thermal catalysed HCl oxidation. These organic constituents include, for example, the solvents used in the isocyanate preparation, such as chlorobenzene, o-dichlorobenzene or p-dichlorobenzene.

Accordingly, in a further process step, the hydrogen chloride produced in the phosgenation is preferably separated from the gaseous product stream. The gaseous product stream obtained in the separation of the isocyanate is treated in such a manner that the phosgene can be fed back to the phosgenation and the hydrogen chloride can be fed to an electrochemical oxidation.

Separation of the hydrogen chloride is preferably carried out by first separating phosgene from the gaseous product stream. Phosgene can be separated off by liquefying phosgene, for example in one or more condensers arranged in series. The liquefaction is preferably carried out at a temperature in the range of from −15 to −40° C., depending on the solvent used. By means of this deep-freezing it is additionally possible to remove portions of the solvent residues from the gaseous product stream.

Additionally or alternatively, the phosgene can be washed out of the gas stream in one or more stages using a cold solvent or solvent/phosgene mixture. Suitable solvents therefor are, for example, the solvents chlorobenzene and o-dichlorobenzene already used in the phosgenation. The temperature of the solvent or of the solvent/phosgene mixture is in the range from −15 to −46° C.

The phosgene separated from the gaseous product stream can be fed back to the phosgenation. The hydrogen chloride obtained after separating off the phosgene and part of the solvent residue can contain, in addition to inert gases such as nitrogen and carbon monoxide, also from 0.1 to 1 wt. % solvent and from 0.1 to 2 wt. % phosgene.

Purification of the hydrogen chloride is then optionally carried out in order to reduce the content of traces of solvent. This can be effected, for example, by means of separation by freezing, where the hydrogen chloride is passed, for example, through one or more cold traps, depending on the physical properties of the solvent.

In a particularly preferred embodiment of the hydrogen chloride purification that is optionally provided, the stream of hydrogen chloride flows through two heat exchangers connected in series, the solvent to be removed being separated out by freezing at, for example, −40° C., depending on the fixed point. The heat exchangers are preferably operated alternately, the solvent previously separated out by freezing being thawed by the gas stream in the heat exchanger that is passed through first. The solvent can be used again for the preparation of a phosgene solution. In the second, downstream heat exchanger, which is supplied with a conventional heat-exchange medium for refrigerating machines, for example a compound from the group of the Freons, the gas is cooled to preferably below the fixed point of the solvent, so that the latter crystallises out. When the thawing and crystallisation operation is complete, the gas stream and the cooling agent stream are changed over, so that the function of the heat exchangers is reversed. In this manner, the solvent content of the hydrogen-chloride-containing gas stream can be reduced to preferably not more than 500 ppm, particularly preferably not more than 50 ppm, very particularly preferably to not more than 20 ppm.

Alternatively, the purification of the hydrogen chloride can be carried out preferably in two heat exchangers connected in series, for example according to U.S. Pat. No. 6,719,957, the entire contents of which are incorporated herein by reference. The hydrogen chloride is thereby preferably compressed to a pressure of from 5 to 20 bar, preferably from 10 to 15 bar, and the compressed gaseous hydrogen chloride is fed at a temperature of from 20 to 60° C., preferably from 30 to 50° C., to a first heat exchanger, where the hydrogen chloride is cooled with cold hydrogen chloride having a temperature of from −10 to −30° C. from a second heat exchanger. Organic constituents condense thereby and can be fed to disposal or re-use. The hydrogen chloride passed into the first heat exchanger leaves it at a temperature of from −20 to 0° C. and is cooled in the second heat exchanger to a temperature of from −10 to −30° C. The condensate formed in the second heat exchanger consists of further organic constituents as well as small amounts of hydrogen chloride. In order to avoid losing hydrogen chloride, the condensate leaving the second heat exchanger is fed to a separating and vaporising unit. This can be a distillation column, for example, in which the hydrogen chloride is driven out of the condensate and fed back into the second heat exchanger. It is also possible to feed the hydrogen chloride that has been driven out back into the first heat exchanger. The hydrogen chloride cooled and freed of organic constituents in the second heat exchanger is passed into the first heat exchanger at a temperature of from −10 to −30° C. After heating to from 10 to 30° C., the hydrogen chloride freed of organic constituents leaves the first heat exchanger.

In an alternative process, which is likewise preferred, the optional purification of the hydrogen chloride of organic impurities, such as solvent residues, takes place on activated carbon by means of adsorption. In that process, for example, the hydrogen chloride, after removal of excess phosgene, is passed over or through bulk activated carbon at a pressure difference of from 0 to 5 bar, preferably from 0.2 to 2 bar. The flow velocity and the dwell time are thereby adapted to the content of impurities in a manner known to the person skilled in the art. The adsorption of organic impurities on other suitable adsorbents, for example on zeolites, is also possible.

In a further alternative process, which is also preferred, distillation of the hydrogen chloride can be provided for the optional purification of the hydrogen chloride from the phosgenation. This is carried out after condensation of the gaseous hydrogen chloride from the phosgenation. In the distillation of the condensed hydrogen chloride, the purified hydrogen chloride is removed as the first fraction of the distillation, the distillation being carried out under conditions of pressure, temperature, etc. that are known to the person skilled in the art and are conventional for such a distillation.

The hydrogen chloride separated and optionally purified according to the processes described above can subsequently be fed to HCl oxidation using oxygen.

The following examples are for reference and do not limit the invention described herein

### EXAMPLES

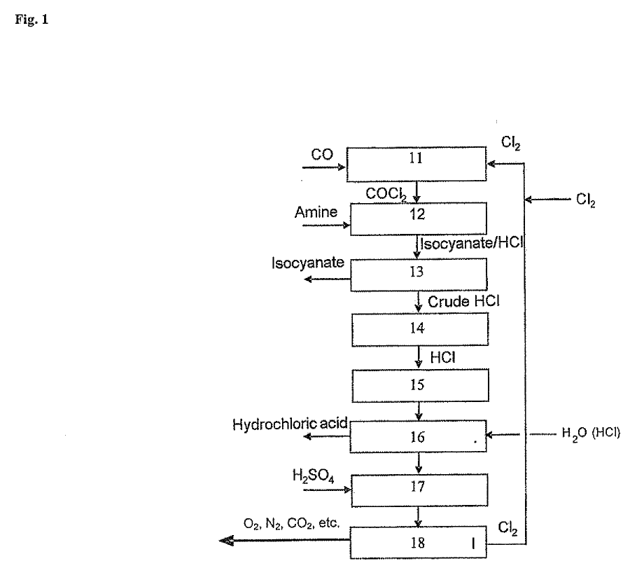

Referring to FIG. 1, in a first stage 11 of an isocyanate preparation, chlorine is reacted with carbon monoxide to give phosgene. In the following stage 12, phosgene from stage 11 is used with an amine (e.g., toluenediamine) to give an isocyanate (e.g., toluene diisocyanate, TDI) and hydrogen chloride, the isocyanate is separated off (stage 13) and utilised, and the HCl gas is subjected to purification 14. The purified HCl gas is reacted in the HCl oxidation process 15 with air (i.e., 20.95 vol % O₂), for example in a Deacon process by means of catalyst.

The reaction mixture from 15 is cooled (step 16). Aqueous hydrochloric acid, which is optionally obtained thereby mixed with water or dilute hydrochloric acid, is discharged.

The gas mixture so obtained, consisting at least of chlorine, oxygen and minor constituents such as nitrogen, carbon dioxide, etc., and is dried with concentrated sulfuric acid (96%) (step 17).

In the gas permeation stage 18, chlorine is separated from the gas mixture from stage 17. The residual stream containing oxygen and minor constituents is released into the environment, with monitoring of pollutants, as the gas mixture from stage 18.

The chlorine gas obtained from the gas permeation 18 is used again directly in the phosgene synthesis 11.

### Tests of Oxidation With Nitrogen Component

A supported catalyst was prepared according to the following process. 10 g of titanium dioxide of rutile structure (Sachtleben) were suspended in 250 ml of water by stirring. 1.2 g of ruthenium(III) chloride hydrate (4.65 mmol. Ru) were dissolved in 25 ml of water. The resulting aqueous ruthenium chloride solution was added to the support suspension. The suspension was added dropwise, in the course of 30 minutes, to 8.5 g of 10% sodium hydroxide solution and then stirred for 60 minutes at room temperature. The reaction mixture was then heated to 70° C. and stirred for a further 2 hours. The solid material was then separated off by centrifugation and washed with 4×50 ml of water until neutral. The solid material was then dried for 24 hours at 80° C. in a vacuum drying cabinet and then calcined for 4 hours at 300° C. in air.

0.5 g of the resulting catalyst was used for activity studies in the case of HCl oxidation in the presence of various concentrations of oxygen and nitrogen. The tests were carried out with pure oxygen, with an oxygen and nitrogen mixture (50% O₂) and with synthetic air (20% O₂+80% N₂). The activities have been listed in Table 1.

TABLE 1

| | | | | Temperature | |
|---|---|---|---|---|---|
| | HCl flow | O₂ flow | N₂ flow | reaction bed | Chlorine conversion (mmol. |
| Test | (1 · h⁻¹) | (1 · h⁻¹) | (1 · h⁻¹) | (° C.) | Cl₂ · min⁻¹ · g(cat)⁻¹) |
| 1 | 2.5 | 1.25 | 0 | 305 | 0.43 |
| 2 | 2.5 | 1.25 | 1.25 | 305 | 0.41 |
| 3 | 2.5 | 1.25 | 5 | 305 | 0.41 |
| 4 | 2.5 | 0.63 | 0 | 306 | 0.24 |
| 5 | 2.5 | 0.63 | 1.25 | 306 | 0.22 |
| 6 | 2.5 | 0.63 | 5 | 306 | 0.22 |

### Description of A Test System For Permeation Measurement

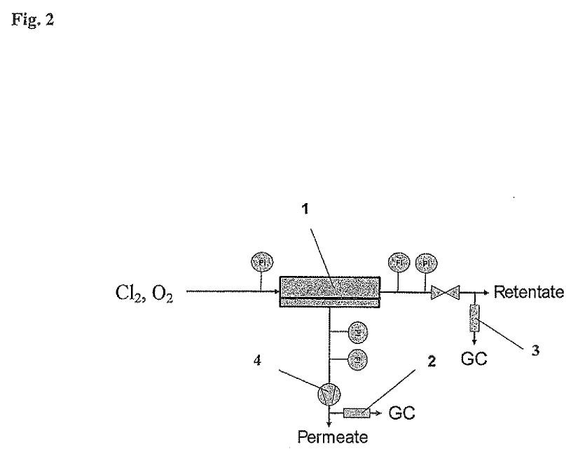

For assessing the efficiency of the membranes, so-called permeation tests using chlorine and oxygen and other minor components are used. The membranes are tested in suitable membrane test cells 1 for carbon membranes and optionally for polymer membranes. FIG. 2 shows the flow diagram of the test apparatus. The feed gas is supplied from compressed gas bottles and is adjusted via flowmeters of the Bronkhorst type. The trans-membrane pressure difference is adjusted either by means of excess pressure on the influx side and/or by connection of a vacuum pump 4 on the permeate side. The permeate flow (m³/m²h) through the membrane is determined with the aid of a flowmeter on the permeate side, by standardisation to the membrane surface area. The gas concentrations are determined by means of sampling 2, 3 by gas chromatography (GC).

### Separation of A Chlorine Gas Mixture Using A Carbon Membrane

A carbon membrane according to M. B. Hägg, Journal of Membrane Science 177 (2000) 109-128, has the following permeabilities:

| T | Permeabilities / Nm³/(m² bar) × 10³ | | | | |
|---|---|---|---|---|---|
| [° C.] | Cl₂ | O₂ | N₂ | H₂ | HCl |
| 30 | 0.09 | 226.6 | 43.6 | 1769 | 684 |
| 60 | | 220.4 | 51 | 1575 | 795 |
| 80 | | 207.6 | 59.3 | 1465 | 795 |

A gas stream having the following composition:

| | |
|---|---|
| nitrogen | 20257 kg/h |
| oxygen | 3050 kg/h |
| carbon dioxide | 270 kg/h |
| chlorine | 9859 kg/h, |

a temperature of 30° C. and a pressure of 20.5 bar, is separated into a permeate stream, which has passed through the membrane, and a retentate stream, which remains upstream of the membrane. During this process a pressure of 100 mbar is applied on the permeate side. The membrane surface area used is 23588 m². The composition of the two resulting product streams is as follows:

| permeate: | |
|---|---|
| nitrogen | 11473 kg/h |
| oxygen | 3007 kg/h |
| carbon dioxide | 266 kg/h |
| chlorine | 17 kg/h |
| retentate: | |
| nitrogen | 8784 kg/h |
| oxygen | 44 kg/h |
| carbon dioxide | 4 kg/h |
| chlorine | 9842 kg/h |

The oxygen-rich retentate stream can be recycled into the process. The chlorine-rich stream is fed to a chlorine processing plant.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A process comprising:
(a) reacting hydrogen chloride and an oxygen-containing gas to form a gas mixture comprising chlorine, water, unreacted hydrogen chloride, and unreacted oxygen, wherein the oxygen-containing gas reacted with the hydrogen chloride has an oxygen content of not more than 99 vol. %;
(b) cooling the gas mixture to form an aqueous solution of hydrogen chloride;
(c) separating at least a portion of the aqueous solution of hydrogen chloride from the gas mixture; and
(d) subjecting the gas mixture to a gas permeation to form a chlorine-rich gas stream and an oxygen-containing partial stream.

2. The process according to claim 1, farther comprising removing at least a portion of any residual water from the gas mixture prior to subjecting the gas mixture to gas permeation.

3. The process according to claim 2, wherein removing at least a portion of any residual water comprises washing the gas mixture with concentrated sulfuric acid.

4. The process according to claim 1, farther comprising removing at least a portion of any residual hydrogen chloride from the gas mixture prior to subjecting the gas mixture to gas permeation.

5. The process according to claim 2, further comprising removing at least a portion of any residual hydrogen chloride from the gas mixture prior to subjecting the gas mixture to gas permeation.

6. The process according to claim 4, wherein removing at least a portion of any residual hydrogen chloride comprises adsorption with water.

7. The process according to claim 1, wherein the oxygen-containing gas has an oxygen content of not more than 95 vol. %.

8. The process according to claim 5, wherein the oxygen-containing gas has an oxygen content of not more than 95 vol. %.

9. The process according to claim 1, wherein the gas permeation comprises passing the gas mixture through a molecular sieve.

10. The process according to claim 9, wherein the molecular sieve has an effective pore size of 0.2 to 1 nm.

11. The process according to claim 1, wherein the gas permeation comprises passing the gas mixture through a membrane comprising a material selected from the group consisting of carbon, silicon dioxide, and zeolites.

12. The process according to claim 1, wherein the gas permeation is carried out at a pressure differential of up to 10⁵ hPa.

13. The process according to claim 1, wherein the gas permeation is carried out at a temperature of up to 400° C.

14. The process according to claim 12, wherein the gas permeation is carried out at a temperature of up to 400° C.

15. The process according to claim 1, wherein the oxygen-containing gas reacted with hydrogen chloride to form the gas mixture comprises a gas selected from the group consisting of air and air enriched with oxygen.

16. The process according to claim 15, wherein the oxygen-containing partial stream is discarded.

17. The process according to claim 1, wherein the hydrogen chloride reacted with the oxygen-containing gas to form the gas mixture comprises a product of an isocyanate preparation process, and at least a portion of the chlorine-rich gas stream is supplied to the isocyanate preparation process.

18. The process according to claim 8, wherein the hydrogen chloride reacted with the oxygen-containing gas to form the gas mixture comprises a product of an isocyanate preparation process, and at least a portion of the chlorine-rich gas stream is supplied to the isocyanate preparation process.

19. The process according to claim 18, wherein the gas permeation comprises passing the gas mixture through a molecular sieve.

20. The process according to claim 19, wherein the molecular sieve has an effective pore size of 0.2 to 1 nm.
